(19) United States
(12) Patent Application Publication
(10) Pub. No.: US 2026/0337328 A1
(43) Pub. Date: Oct. 29, 2026

(54) THERMOPLASTIC POLYURETHANE COMPOSITIONS WITH SHAPE MEMORY PROPERTIES

(71) Applicant: Lubrizol Advanced Materials, Inc., Cleveland, OH (US)

(72) Inventors: JOAN CARLES BAYON RUEDA, Barcelona (ES); NIKOLA KOCIC, Barcelona (ES); MARÍA JOSEP RIBA GARCÍA, Barcelona (ES); DANIEL GARCIA-MARTOS, Barcelona (ES)

(73) Assignee: Lubrizol Advanced Materials, Inc., Cleveland, OH (US)

(21) Appl. No.: 19/111,457

(22) PCT Filed: Sep. 14, 2023
(86) PCT No.: PCT/US2023/032681

§ 371 Date: Mar. 13, 2025

(30) Foreign Application Priority Data
Sep. 15, 2022 (EP) 22382851.8

(51) Int. Cl. C08G 18/42; C08K 5/053

(52) U.S. Cl. CPC C08G 18/4258; C08K 5/053; C08G 2280/00

(57) ABSTRACT

A thermoplastic polyurethane composition having shape memory properties comprises the reaction product of a polyester polyol component comprising a short chain diol and a dicarboxylic acid, such as 2,5-furandicarboxylic acid, a diisocyanate component, and a chain extender component.

### FIELD OF THE INVENTION

The present invention relates to thermoplastic polyurethane (TPU) compositions with excellent shape memory and thermomechanical properties, which can be used for molded articles.

### BACKGROUND OF THE INVENTION

Thermoplastic polyurethanes (TPU) are an excellent choice of material for many applications owing to their easy processing and outstanding properties, including resistance to abrasion, impact and chemical agents, high flexibility and cut, good environmental weathering, and biocompatibility.

As is well known, TPUs are prepared by reacting diisocyanate compounds, polymeric diols and difunctional chain extenders. Typically, high amounts of diisocyanate and chain extenders need to be employed to obtain products with high hardness that maintain the mechanical properties of the material. However, owing to the high toxicity and environmental impact of the diisocyanates, said high hardness materials present a high environmental footprint. Hence, the development of high hardness materials with limited amount of the hazardous diisocyanate is of special interest to manufacture more environmentally friendly TPUs.

The development of thermally-induced shape memory polymers (SMPs) has gained attraction thanks to their added interest properties, such as recovery stress and energy output. These materials can switch form a plastic deformation behavior to an elastic one when triggered by an external stimulus, such as heat, light or electricity. SMPs perform a mechanical work when the switch in deformation behavior occurs. In particular, heat activated SPMs, those that toggle between both behaviors upon reaching either a glass transition temperature (T_{g}) or a melting transition temperature (Tₘ), can be exploited for many applications in different fields, like in medical implants or devices, smart actuators or self-deploying structures.

Shape memory polymers and molded articles are disclosed for instance in US2008221279A1 and U.S. Ser. No. 10/907,006B2.

Nevertheless, there is still a general need in the state of the art of SMPs with less toxicity, high recovery stress and energy output. The present invention sets out to meet some or all of the above-identified needs and to solve some or all of the above-identified problems.

### SUMMARY OF THE INVENTION

The invention relates to thermoplastic polyurethane compositions with shape memory properties.

In one aspect, the invention relates to a thermoplastic polyurethane composition comprising the reaction product of:
(a) a polyester polyol comprising a short chain diol and a dicarboxylic acid selected from the group consisting of 2,5-furandicarboxylic acid.
(b) a diisocyanate component; and
(c) a chain extender component.

The thermoplastic polyurethane compositions are suitable for manufacturing molded articles with shape memory properties.

In another aspect, the invention relates to a molded article comprising the thermoplastic polyurethane composition according to the first aspect.

The following embodiments of the present subject matter are contemplated:

1. A thermoplastic polyurethane composition comprising the reaction product of: (a) a polyester polyol comprising a short chain diol and 2,5-furandicarboxylic acid; (b) a diisocyanate component; and (c) a chain extender component.

2. The thermoplastic polyurethane composition according to embodiment 1, wherein the polyester polyol has a number average molecular weight lower than 5,000 Da.

3. The thermoplastic polyurethane composition according to either embodiment 1 or embodiment 2, wherein the polyester polyol has a number average molecular weight in the range from 800 to 5,000 Da, preferably from 1,000 to 3,000 Da.

4. The thermoplastic polyurethane composition according to any one of embodiments 1 to 3, wherein the diisocyanate is in an amount to provide a NCO:OH molar ratio of from 1:1.25 to 1.25:1.

5. The thermoplastic polyurethane composition according to any one of embodiments 1 to 4, wherein the molar ratio of chain extender to polyol is from 1:1 to 1:9.

6. The thermoplastic polyurethane composition according to any one of embodiments 1 to 5, wherein the molar ratio of 2,5-furandicarboxylic acid to short chain diol of the polyester polyol (a) is from 1:1 to 1:5 or 1:1 to 1:2, or 1:1 to 1:1.5, or 1:1 to 1:1.25.

7. The thermoplastic polyurethane composition according to any one of embodiments 1 to 6, wherein the short chain diol is selected from the group consisting of 1,4-butanediol (BDO) and 1,6-hexanediol (HDO), 1,3-propanediol (PDO) or mixtures thereof.

8. The thermoplastic polyurethane composition according to any one of embodiments 1 to 7, wherein the chain extender component comprises or consists of 1,4-butanediol.

9. The thermoplastic polyurethane composition according to any one of embodiments 1 to 7, wherein the chain extender component comprises or consists of 1,3-propanediol (PDO), optionally wherein the diisocyanate component is selected from the group consisting of aromatic diisocyanates and aliphatic diisocyanates or mixtures thereof.

10. The thermoplastic polyurethane composition of any one of embodiments 1 to 9, wherein the diisocyanate component is selected from diphenyl diisocyanate (MDI), hexamethylene diisocyanate (HDI), or mixtures thereof.

11. The thermoplastic polyurethane composition of any one of embodiments 1 to 10, wherein the diisocyanate component comprises or consists of MDI.

12. The thermoplastic polyurethane composition of any one of embodiments 1 to 11, wherein the diisocyanate component comprises or consists of HDI.

13. The thermoplastic polyurethane composition according to any one of embodiments 1 to 12, wherein the thermoplastic polyurethane has a hard segment content of 2 to 50 wt. % or 7 to 36 wt %.

14. The thermoplastic polyurethane composition according to any one of embodiments 1 to 13, wherein the thermoplastic polyurethane shows a shore D hardness of at least 60, or at least 70, or at least 80, or at least 86, or at least 90 as determined by ISO 7619-1:2010.

15. The thermoplastic polyurethane composition according to any one of embodiments 1 to 14, wherein the thermoplastic polyurethane shows a recovery stress of from 1 to 30 MPa, preferably from 14 to 30 MPa.

16. The thermoplastic polyurethane composition according to any one of embodiments 1 to 15, wherein the thermoplastic polyurethane shows energy output of from 0.6 to 30 MJ/m3 or from 8 to 30 MJ/m3.

17. A molded article comprising the thermoplastic polyurethane composition according to any one of embodiments 1 to 16.

18. A molded article according to embodiment 17, wherein the molding article is a medical device.

### DETAILED DESCRIPTION OF THE INVENTION

The articles “a” and “an” are used herein to refer to one or to more than one (i.e., to at least one) of the grammatical object of the article unless the context clearly indicates otherwise. By way of example, “an element” means one element or more than one element.

Except in the Examples, or where otherwise explicitly indicated, all numerical quantities in this description specifying amounts of materials, reaction conditions, molecular weights, number of carbon atoms, and the like, are to be understood as modified by the word “about”. The term “about” as used herein, e.g. when referring to a measurable value (such as an amount or weight of a particular component or temperature), refers to variations of ±20%, ±10%, ±5%, ±1%, ±0.5%, or, particularly, ±0.1% of the specified amount. Except where otherwise indicated, all numerical quantities in the description specifying amounts or ratios of materials are on a weight basis.

As used herein, the term “comprising”, which is inclusive or open-ended and does not exclude additional unrecited elements or method steps, is intended to encompass as alternative embodiments, the phrases “consisting essentially of” and “consisting of” where “consisting of” excludes any element or step not specified and “consisting essentially of” permits the inclusion of additional unrecited elements or steps that do not materially affect the essential or basic and novel characteristics of the composition or method under consideration.

Temperature activated shape memory polymers are materials that can switch between a permanent and preprogramed temporary shape depending on their temperature. Said materials can be deformed and cooled below their switching temperature to their temporary shape, which will be stored by the material until the temperature is increased again and overcomes the switching temperature.

The present invention provides shape memory TPU compositions with desirable hardness, recovery stress, energy output and temperature resilience.

### Polyester Polyol Component

The polyester polyol comprises a short chain diol and 2,5-furandicarboxylic acid (FDCA).

FDCA is member of the class of furans carrying two carboxy substituents at positions 2 and 5. FDCA is a renewable carboxylic acid that can prepared from carbohydrates and is also found as a natural product, for example as a natural product found in fungi such as Phomopsis velata.

Suitable short-chain diols include for example those having from 2 to 12 carbon atoms. Suitable diols may include, for example, ethylene glycol, 1,2-propanediol, 1,3-propanediol (PDO), 1,3-butanediol, 1,4-butanediol, 1,5-pentanediol, 1,6-hexanediol (HDO), 2,2-dimethyl-1,3-propanediol, 1,4-cyclohexane dimethanol, decamethylene glycol, dodecamethylene glycol, and the like. Particularly, the short-chain diol used in the invention may be HDO, PDO or mixtures thereof. In one embodiment the short-chain diol comprises, or even consist essentially of HDO. In one embodiment the short-chain diol comprises, or even consist essentially of PDO.

In one embodiment, the number average molecular weight (Mn) of the polyol component of the present invention, which can comprise polyols as defined above, is from about 250 to about 5,000, for example, about 1,000 to about 3,000 Da. When referred to herein, the Mn of the polyols is determined by ¹H NMR end-group analysis, through the integration of the signals corresponding to the protons of the terminal CH₂OH and alpha ester protons.

In one embodiment, the molar ratio of 2,5-furandicarboxylic acid to short chain diol of the polyester polyol (a) is from 1:1 to 1:5 or 1:1 to 1:2, or 1:1 to 1:1.5, or 1:1 to 1:1.25

### Diisocyanate Component

The diisocyanate component of the present invention can be selected from any diisocyanate known to those skilled in the art. Useful diisocyanates can be selected from aromatic isocyanates, aliphatic isocyanates or combinations thereof. Non-limiting examples of useful diisocyanates can include aromatic diisocyanates such as 4,4′-methylenebis(phenyl isocyanate) (MDI), 3,3′-dimethyl-4,4′-biphenylene diisocyanate (TODI), m-xylene diisocyanate (XDI), 1,4-phenylene diisocyanate, 1,5-naphthalene diisocyanate (NDI), and toluene diisocyanate (TDI), as well as aliphatic diisocyanates such as isophorone diisocyanate (IPDI), 1,4-cyclohexyl diisocyanate (CHDI), 1,6-hexamethylene diisocyanate (HDI), 1,10-decamethylene diisocyanate, lysine diisocyanate (LDI), 1,4-butane diisocyanate (BDI), and 4,4′-dicyclohexylmethane diisocyanate (H12 MDI). Mixtures of two or more diisocyanates may be used. Particularly, the diisocyanate can be MDI and/or HDI. More particularly, the diisocyanate component comprises or even consists essentially of MDI. In some embodiments, the diisocyanate component comprises or even consists essentially of HDI.

The thermoplastic polyurethane composition can comprise the reaction product of a polyester polyol comprising a short chain diol selected from the group consisting of PDO and HDO, and 2,5-furandicarboxylic acid (FDCA); a diisocyanate component comprising or consisting essentially of MDI and/or HDI; and a chain extender.

In one embodiment, the thermoplastic polyurethane composition may comprise of the reaction product of a polyester polyol comprising PDO and 2,5-furandicarboxylic acid (FDCA); a diisocyanate component selected from the group consisting of MDI and HDI or mixtures thereof, and a chain extender.

In another embodiment, the thermoplastic polyurethane composition may comprise or consist of the reaction product of a polyester polyol comprising, consisting essentially of, or consisting of PDO and 2,5-furandicarboxylic acid (FDCA); a diisocyanate component comprising or consisting of MDI and a chain extender. In still another embodiment, the thermoplastic polyurethane composition may comprise or consist of the reaction product of a polyester polyol comprising, consisting essentially of, or consisting of PDO and 2,5-furandicarboxylic acid (FDCA); a diisocyanate component comprising or consisting of HDI and a chain extender.

In another embodiment, the thermoplastic polyurethane composition may comprise or consist of the reaction product of a polyester polyol comprising, consisting essentially of or consist of HDO and 2,5-furandicarboxylic acid (FDCA); a diisocyanate component comprising or consisting of HDI and a chain extender. In another embodiment, the thermoplastic polyurethane may comprise or consist of the reaction product of a polyester polyol comprising, consisting essentially of, or consisting of HDO and and 2,5-furandicarboxylic acid (FDCA); a diisocyanate component comprising or consisting of MDI and a chain extender.

### Chain Extenders

Chain extenders are desirably employed in the polyurethane formulations of the present invention to increase the molecular weight thereof. They are also responsible for formation of crystalline hard blocks leading to thermoplastic polyurethanes with desirable mechanical properties.

Suitable chain extenders include relatively small polyhydroxy compounds, for example, lower aliphatic or short chain diols having from 2 to 20, or 2 to 12, or 2 to 10 carbon atoms. Suitable examples include ethylene glycol, diethylene glycol, triethylene glycol, tetraethylene glycol, propylene glycol, dipropylene glycol, 1,4-butanediol (BDO), 1,6-hexamethylene diol (HDO), 1,3-butanediol, 1,5-pentanediol, neopentylglycol, 1,4-cyclohexanedimethanol (CHDM), 2, 2-bis[4-(2-hydroxy ethoxy) phenyl]propane (HEPP), heptanediol, nonanediol, dodecanediol, 3-methyl-1,5-pentanediol, ethylenediamine, butanediamine, hexamethylenediamine, and hydroxy ethyl resorcinol (HER), pentaspiro glycol (PSG), hydroquinone bis(2-hydroxy ethyl) ether hydroquinone (HQEE), dipropylene glycol (DPG), 2-methyl-I,3-propane diol, 2-butyl-2-ethyl-1,3-propane diol (BEPD), and the like, as well as mixtures thereof. In one embodiment, the chain extender comprises, or even consist essentially of 1,4-butanediol (BDO).

The molar ratio of chain extender to polyol can be from 1:1 to 1:9.

The hard segment content of a thermoplastic polyurethane composition is defined as the combined weight percent of the diisocyanate component and the chain extender component.

One of the advantages of the TPU compositions of the present invention is that they show high hardness even at low concentrations of hard segment.

Thus, in some embodiments of the present invention, the thermoplastic polyurethanes herein can have a hard segment content of 50% by weight or lower. Particularly, the hard segment content can be of 2% to 50% by weight, or from 7 to 36% by weight.

In one embodiment, the thermoplastic polyurethane composition shows a shore D hardness of at least 60, or of at least 70, or of at least 80, or of at least 86 or of at least 90 as determined by ISO 7619-1:2010.

The thermoplastic polyurethane composition can have a shore D hardness as determined by ISO 7619-1:2010 of at least 61 and a hard segment content from 7 to 36% by weight.

The thermoplastic polyurethane composition can have a molar ratio of chain extender to polyol from 1:1 to 1:9.

In one embodiment, the diisocyanate is in an amount to provide a NCO:OH molar ratio from 1:1.25 to 1.25:1, particularly from 1:1.1 to 1.1:1

In some embodiments, the TPU compositions of the present invention exhibit desirable elongation and strain properties. For example, the TPU compositions may have an ultimate tensile strength of at least of 28 MPa and strain of at least of 11%, when measured using a dumbbell sample prepared according to ISO 37 1A and using the process according to ISO 37 1A with the modification that a rate of 5 mm/min at 21 °C is used. TPU compositions may also be tested for shape fixity (R_{f}) and recovery (Rᵣ) properties. Shape fixity refers to the percentage of the elongation induced into the material that is maintained at 20 °C below the transition temperature of the material under no load after it being deformed to its temporary shape and it is calculated as follows:

$${R}_{f} = \frac{{ε}_{f} ( n )}{{ε}_{m}} \times 100$$

Where ε_{f}(n) is the strain of the system after elongation at 20 °C below the transition temperature once the stress has been released and εₘ is the maximum strain applied to the system. Shape recovery refers to the percentage of the initial shape before deformation that is recovered once the material is heated to 20 °C above the transition temperature of the material under no load after its deformation to the temporary shape and it is calculated as follows:

$${R}_{r} = \frac{{ε}_{f} ( n ) - {ε}_{r} ( n )}{{ε}_{m} - {ε}_{0}} \times 100$$

Where ε_{f}(n) is the strain of the system after elongation at 20 °C below the transition temperature once the stress has been released, εₘ is the maximum strain applied to the system, εᵣ(n) is the strain of the sample in the stress-free state at 20 °C above the transition temperature after the 30 minutes of recovery time and ε₀ is the strain of the sample at the start of the cycle. Shape fixity and recovery may be measured by a process involving the following steps: (1) Set the temperature to 20 °C above the T_{g} of the materials; (2) Isothermal hold for 5 minutes; (3) Increase strain to 100% at a rate of 50%/min; (4) Isothermal hold for 5 minutes; (5) Decrease temperature to 20 °C below T_{g} at a rate of −10 °C/min; (6) Isothermal hold for 5 minutes; (7) Set force to 0.001N; (8) Isothermal hold for 5 minutes; (9) Increase temperature to 20 °C above the T_{g} of the materials at a rate of 10 °C/min; (10) Isothermal for 30 minutes. Step 3-10 are repeated two times to complete three cycles to report results. The equipment for measuring shape fixity and recovery may be measured any known suitable instruments, such as a DMA Q800 from TA Instruments.

Desirable properties for shape memory polymers include good recovery stress and energy output. These two properties define how much strength (recovery stress) and energy output (volumetric energy density) the material is capable of generating when moving from the temporary shape to the permanent one. TPU compositions as disclosed herein have been observed to exhibit recovery stress and energy output.

The TPU compositions disclosed herein can have a recovery stress of from 1 to 30 MPa, particularly of from 14 to 30 MPa.

Based on the detailed examples the skilled person is routinely able to repeat the assay to objectively determine the recovery stress of the TPU compositions.

For example, to measure the recovery stress of the TPU compositions, the recovery stress is determined at 20 °C above the glass transition temperature (T_{g}) of each material on ISO37 1A dumbbell samples. The value corresponds to the stress of the material once it has been elongated to 90% of its ultimate strain at 20 °C above the T_{g} and then allowed to relax with fixed elongation for 5 minutes. The T_{g} of samples can be measured using the method following ISO 11357-2. As used in the present invention, T_{g} was measured using IS 11357-2, but employing a heating and cooling rate of 10 °C/min.

The TPU compositions disclosed herein can have an energy output (volumetric energy density) of from 0.6 to 30 MJ/m³, particularly from 8 to 30 MJ/m³, more particularly from 20 to 30 MJ/m³.

Based on the detailed examples the skilled person is routinely able to repeat the assay to objectively determine the energy output of the TPU compositions.

For example, in order to measure the energy output (volumetric energy density) of the TPU compositions, the energy output is calculated as the extrapolated area between the Recovery Stress and its elongation as reported in Copper et al. [Cooper, C et al. High Energy Density Shape Memory Polymers Using Strain-Induced Supramolecular Nanostructures. ACS Cent. Sci. 2021, 7 (10), 1657-1667. https://doi.org/10.1021/acsentsci.1c00829] as follows:

$$Energy output = \frac{0.5 \times Recovery Stress \times Elongation at Recovery Stress ( \% )}{100}$$

TPU compositions of the present invention are formed by reacting a polyester polyol component and a hard segment component comprising a diisocyanate and a chain extender, and optionally, a catalyst.

The three reactants (the polyol polyester, the diisocyanate, and the chain extender) are reacted together to form the TPU of this invention. Any known processes to react the three reactants may be used to make the TPU.

The process can be the so-called “one-shot” process where all three reactants are added to an extruder reactor and reacted. The reaction may comprise melting the polyol at 140 to 180 °C and adding diisocyanates and chain extender, and optionally catalyst and/or additives.

Thus, in one embodiment, the process comprises melting the polyester polyol at a temperature from 140 to 180 °C to melt the polyester polyol and adding the diisocyanate and chain extender. The process may further include adding catalysts and/or additives.

The TPU can also be prepared utilizing a pre-polymer process. In the pre-polymer route, the polyol intermediates are generally reacted with an equivalent excess of one or more diisocyanates to form a pre-polymer solution having free or unreacted diisocyanate therein. The reaction is generally carried out at temperatures of from about 80 to about 220 °C, or from about 150 to about 200 °C, optionally, in the presence of a suitable urethane catalyst. Subsequently, a chain extender, as noted above, is added in an equivalent amount generally equal to the isocyanate end groups as well as to any free or unreacted diisocyanate compounds. The chain extension reaction temperature is generally from about 180 to about 250 °C or from about 200 to about 240 °C. Typically, the pre-polymer route can be carried out in any conventional device including an extruder. In such embodiments, the polyol intermediates are reacted with an equivalent excess of a diisocyanate in a first portion of the extruder to form a pre-polymer solution and subsequently the chain extender is added at a downstream portion and reacted with the pre-polymer solution. Any conventional extruder can be utilized, including extruders equipped with barrier screws having a length to diameter ratio of at least 20 and in some embodiments at least 25.

### Auxiliary Substances and Catalysts

Optionally, catalysts, auxiliary substances and/or additives can be used in the polyurethane reaction mixtures of the present invention.

Any of the catalysts conventionally employed or known in the art to catalyze the reaction of an isocyanate with a reactive hydrogen containing compound can be employed for this purpose. Examples of suitable catalysts which in particular accelerate the reaction between the NCO groups of the diisocyanates and the hydroxy groups of the polyols and chain extenders are the conventional tertiary amines known from the prior art, e.g. triethylamine, dimethyl cyclohexylamine, N-methylmorpholine, N,N′-dimethylpiperazine, 2-(dimethylaminoethoxy)ethanol, diazabicyclo[2,2,2]octane and the like, and also in particular organometallic compounds, such as titanic esters, iron compounds, e.g. ferric acetyl acetonate, bismuth compounds, e.g. bismuth octanoate, bismuth neodecanoate, bismuth laureate, tin compounds, e.g. stannous diacetate, stannous dioctoate, stannous dilaurate, or the dialkyltin salts of aliphatic carboxylic acids, e.g. dibutyltin diacetate, dibutyltin dilaurate, or the like phenyl mercuric propionate, lead octoate, iron acetylacetonate, magnesium acetylacetonate, and the like. Mixtures of the above noted catalysts can likewise be used.

Auxiliary substances and/or additives may also be added. Suitable, non-limiting examples include lubricants such as fatty acid esters, their metal soaps, fatty acid amides, fatty ester amides and silicone compounds, anti-blocking agents, inhibitors, stabilizers against hydrolysis, light, heat and discoloration, flameproofing agents, flame retardant agents, dyes, pigments, inorganic and/or organic fillers and reinforcing agents.

### Applications

Thermoplastic polyurethane (TPU) compositions described above are highly useful materials that can provide an attractive combination of physical properties, particularly mechanical and shape memory properties.

The compositions of the invention and any blends thereof are useful in a wide variety of applications. Non-limiting examples of articles comprising the TPU compositions of the invention may include cook and storage ware, articles such as furniture, automotive components, toys, sportswear, medical devices, eyeglasses, including eyeglass frames and temple pieces, sterilizable medical devices, sterilization containers, fibers, woven fabrics, nonwoven fabrics, drapes, gowns, filters, hygiene products, diapers, and films, oriented films, sheets, tubes, pipes, wire jacketing, cable jacketing, agricultural films, geomembranes, sporting equipment, cast film, blown film, boat and water craft components, and other such articles. The compositions may be suitable for automotive components such as bumpers, grills, trim parts, dashboards and instrument panels, exterior door and hood components, spoiler, wind screen, windshield wipers, hub caps, mirror housing, body panel, protective side molding, and other interior and external components associated with automobiles, trucks, boats, and other vehicles.

Other useful articles may be formed from the compositions of the invention including: crates, containers, packaging, labware, such as roller bottles for culture growth and media bottles, office floor mats, instrumentation sample holders and sample windows; liquid storage containers such as bags, pouches, and bottles for storage and IV infusion of blood or solutions; packaging material including those for any medical device or drugs including unit-dose or other blister or bubble pack as well as for wrapping or containing food preserved by irradiation. Other useful items include medical tubing and valves for any medical device including infusion kits, catheters, and respiratory therapy, as well as packaging materials for medical devices or food which is irradiated including trays, as well as stored liquid, particularly water, milk, or juice, containers including unit servings and bulk storage containers as well as transfer means such as tubing, hoses, pipes, and such, including liners and/or jackets thereof.

In the medical field, suture threads that have their shape memory switch temperature at around body temperature can be generated. These sutures, upon reaching body temperature would tighten, securing the stiches without requiring the intervention of the surgeon. Self-expanding shape memory stents allow the deployment of contracted stents that, upon being placed in position and heated by the body temperature, expand to their full size. This allows an easier insertion of the stent and minimizes the harm done upon introduction of the device.

Light weight self-deployable structures for smart buildings, like in adaptive sun shading, or for the aerospace field, like solar sails can also be made.

The articles can be made or prepared by any useful process for forming thermoplastic polyurethane materials. This will include, at least, molding, including compression molding, injection molding, blow molding, and transfer molding; film blowing or casting; extrusion, and thermoforming; as well as by lamination, pultrusion, draw reduction, rotational molding, spin-bonding, melt spinning, melt blowing; fiber spinning, electrospinning or combinations thereof. Use of at least thermoforming or film applications allows for the possibility of and derivation of benefits from uniaxial or biaxial orientation of the material.

The present invention will be better understood by reference to the following examples, which serve to illustrate the invention, but not to limit the same.

### Examples

### ABBREVIATIONS

The following abbreviations are used in the examples: MDI=4,4′-methylenebis(phenyl isocyanate) and HDI=1,6-hexamethylene diisocyanate.

### Synthesis of Thermoplastic Polyurethanes

A series of different thermoplastic polyurethanes were synthetised as disclosed in Table 1 using 1,4-butanediol as chain extender. The NCO:OH ratio was of 1:1. The shore D hardness and glass transition temperature (T_{g}) of the materials of the Examples were determined according to the following methods:
Hardness was calculated according to ISO 7619-1:2010
Glass transition temperature was determined on DSC as the mean of the T_{g} values of the second cooling and heating. Data obtained using a heating/cooling rate of 10 °C/min.

The measured hardness and T_{g} values are included in Table 1.

TABLE 1
TPU Compositions and Physical Properties

| | | Polyester | | Hard | | |
|---|---|---|---|---|---|---|
| | | Mₙ | | Segment | Hardness | T_{g} |
| Ex. | Polyester | (g/mol) | Diisocyanate | (wt %) | (Shore D) | (°C) |
| 1 | Polypropylene | 990 | MDI | 22.6 | 81 | 60.2 |
| | isophthalate | | | | | |
| 2 | Polypropylene | 1090 | MDI | 26.7 | 81 | 58.9 |
| | isophthalate | | | | | |
| 3 | Polypropylene | 1110 | MDI | 34.7 | 77 | 65.1 |
| | isophthalate | | | | | |
| 4 | Polypropylene | 1950 | MDI | 12.9 | 81 | 48.6 |
| | isophthalate | | | | | |
| 5 | Polypropylene | 1950 | MDI | 16.9 | 86 | 51.9 |
| | isophthalate | | | | | |
| 6 | Polypropylene | 2300 | MDI | 20.4 | 80 | 58.7 |
| | isophthalate | | | | | |
| 7 | Polyhexamethylene | 1030 | MDI | 21.9 | 70 | 28.7 |
| | isophthalate | | | | | |
| 8 | Polyhexamethylene | 1030 | MDI | 27.8 | 74 | 36.3 |
| | isophthalate | | | | | |
| 9 | Polyhexamethylene | 1030 | MDI | 36.5 | 75 | 42.2 |
| | isophthalate | | | | | |
| 10 | Polyhexamethylene | 1910 | MDI | 13.1 | 33 | 19.0 |
| | isophthalate | | | | | |
| 11 | Polyhexamethylene | 1930 | MDI | 17.0 | 39 | 23.5 |
| | isophthalate | | | | | |
| 12 | Polyhexamethylene | 2020 | MDI | 22.6 | 65 | 26.8 |
| | isophthalate | | | | | |
| 13 | Polypropylene | 1110 | HDI | 15.1 | 81 | 30.6 |
| | isophthalate | | | | | |
| 14 | Polypropylene | 1130 | HDI | 19.8 | 81 | 28.9 |
| | isophthalate | | | | | |
| 15 | Polypropylene | 1110 | HDI | 27.8 | 72 | 26.9 |
| | isophthalate | | | | | |
| 16 | Polypropylene | 2380 | HDI | 7.7 | 75 | 34.1 |
| | isophthalate | | | | | |
| 17 | Polypropylene | 2480 | HDI | 10.1 | 74 | 32.7 |
| | isophthalate | | | | | |
| 18 | Polypropylene | 2520 | HDI | 14.5 | 72 | 31.6 |
| | isophthalate | | | | | |
| 19 | Polyhexamethylene | 1180 | HDI | 14.3 | 32 | 2.9 |
| | isophthalate | | | | | |
| 20 | Polyhexamethylene | 1180 | HDI | 19.1 | 36 | 5.3 |
| | isophthalate | | | | | |
| 21 | Polyhexamethylene | 1180 | HDI | 26.5 | 45 | 5.2 |
| | isophthalate | | | | | |
| 22 | Polyhexamethylene | 1900 | HDI | 9.4 | 33 | 4.8 |
| | isophthalate | | | | | |
| 23 | Polyhexamethylene | 1680 | HDI | 14.2 | 39 | 5.2 |
| | isophthalate | | | | | |
| 24 | Polyhexamethylene | 1920 | HDI | 18.2 | 39 | 6.5 |
| | isophthalate | | | | | |
| 25 | Polypropylene 2,5- | 1130 | MDI | 20.4 | 90 | 68.7 |
| | furandicarboxylate | | | | | |
| 26 | Polypropylene 2,5- | 1060 | MDI | 35.9 | 91 | 65.8 |
| | furandicarboxylate | | | | | |
| 27 | Polypropylene 2,5- | 1660 | MDI | 19.2 | 96 | 60.4 |
| | furandicarboxylate | | | | | |
| 28 | Polypropylene 2,5- | 1820 | MDI | 13.7 | 95 | 55.5 |
| | furandicarboxylate | | | | | |
| 29 | Polypropylene 2,5- | 2210 | MDI | 21.1 | 96 | 60.7 |
| | furandicarboxylate | | | | | |
| 30 | Polyhexamethylene | 1200 | MDI | 19.4 | 96 | 12.2 |
| | 2,5-furandicarboxylate | | | | | |
| 31 | Polyhexamethylene | 1220 | MDI | 32.6 | 94 | 44.1 |
| | 2,5-furandicarboxylate | | | | | |
| 32 | Polyhexamethylene | 1620 | MDI | 19.7 | 96 | 30.9 |
| | 2,5-furandicarboxylate | | | | | |
| 33 | Polyhexamethylene | 2110 | MDI | 12.0 | 95 | 26.6 |
| | 2,5-furandicarboxylate | | | | | |
| 34 | Polyhexamethylene | 2130 | MDI | 21.7 | 96 | 30.2 |
| | 2,5-furandicarboxylate | | | | | |
| 35 | Polypropylene 2,5- | 1050 | HDI | 16.1 | 93 | 40.8 |
| | furandicarboxylate | | | | | |
| 36 | Polypropylene 2,5- | 1040 | HDI | 30.4 | 93 | 36.6 |
| | furandicarboxylate | | | | | |
| 37 | Polypropylene 2,5- | 1560 | HDI | 15.7 | 94 | 43.6 |
| | furandicarboxylate | | | | | |
| 38 | Polypropylene 2,5- | 2010 | HDI | 9.1 | 95 | 47.7 |
| | furandicarboxylate | | | | | |
| 39 | Polypropylene 2,5- | 1990 | HDI | 18.6 | 93 | 42.9 |
| | furandicarboxylate | | | | | |
| 40 | Polyhexamethylene | 1180 | HDI | 14.4 | 61 | 9.6 |
| | 2,5-furandicarboxylate | | | | | |
| 41 | Polyhexamethylene | 1050 | HDI | 28.8 | 62 | 11.5 |
| | 2,5-furandicarboxylate | | | | | |
| 42 | Polyhexamethylene | 1660 | HDI | 14.4 | 65 | 11.9 |
| | 2,5-furandicarboxylate | | | | | |
| 43 | Polyhexamethylene | 1820 | HDI | 9.8 | 66 | 13.6 |
| | 2,5-furandicarboxylate | | | | | |
| 44 | Polyhexamethylene | 1950 | HDI | 17.9 | 63 | 12.2 |
| | 2,5-furandicarboxylate | | | | | |
| 45 | Polybutylene adipate | 1000 | MDI | 50.0 | 33 | n.d. |
| 46 | Polybutylene adipate | 1000 | MDI | 88.2 | 60 | n.d. |

As general trend, the hardness of TPUs with similar hard segment content is higher for FDCA than standard TPUs with aliphatic polyols (i.e. ADPBDO) and even higher than TPUs made with other aromatic polyols, such as IPHTA. The same trend was observed for glass transition temperature.

### Recovery Stress/Energy Output/Resilience Measurements

For each of the Example TPU compositions, recovery stress, energy output, and resilience temperature were measured.

Recovery stress and energy output were measured as described herein using a DMA Q800 from TA Instruments at 20 °C above the T_{g} of each material on ISO37 1A dumbbell samples. To determine the recovery stress of the sample, the material was elongated to 90% of its maximum strain at a rate of 50%/minute. Then, the material was allowed to relax under fixed elongation during 5 minutes and the value of stress posterior to said relaxation was selected as the recovery stress of the material.

Energy output (volumetric energy density) was calculated as the extrapolated area between the Recovery Stress and its elongation as reported in Copper et al. [Cooper, C et al., High Energy Density Shape Memory Polymers Using Strain-Induced Supramolecular Nanostructures. ACS Cent. Sci. 2021, 7 (10), 1657-1667. https://doi.org/10.1021/acscentsci.1c00829] as follows:

$$Energy output = \frac{0.5 \times Recovery Stress \times Elongation at Recovery Stress ( \% )}{100}$$

The resilience to temperature of the mechanical properties of the TPU compositions has been studied by dynamic mechanical analysis. This resilience is important as, the higher it is, the higher the maximum service temperature of the materials will be. Therefore, if the materials are to be used for applications in which the material is required to withstand high temperatures, high resilience to temperature is needed. For assessing the trends of these temperature resilience, dynamic mechanical analysis (DMA) has been employed. This has been done by using the ASTM D4045-06 test with the modification that the material is heated at a rate of 5 °C/minute from −50 °C at a frequency of 1 Hz with a 10 μm amplitude on a dual cantilever clamp on 35×15×2.5-3 mm samples and determining the temperature at which the material reached a storage modulus of 5 MPa.

The results of the Recovery Stress, Energy Output, and Resilience measurements are listed in Table 2.

TABLE 3
Energy output and recovery stress of each of the samples

| | Recovery | Energy | Resilience |
|---|---|---|---|
| | Stress | output | Temperature |
| Ex. | (MPa) | (MJ/m³) | (°C) |
| 1 | <0.5 | <0.3 | 118 |
| 2 | 1.2 | 2.0 | 116 |
| 3 | <0.5 | <0.3 | 145 |
| 4 | <0.5 | <0.3 | 124 |
| 5 | 0.7 | 0.6 | 119 |
| 6 | 0.7 | 0.7 | 110 |
| 7 | 0.9 | 2.0 | 90 |
| 8 | 1.0 | 1.5 | 102 |
| 9 | 1.8 | 2.1 | 105 |
| 10 | 2.3 | 0.5 | 87 |
| 11 | 2.6 | 5.5 | 91 |
| 12 | 1.9 | 3.6 | 115 |
| 13 | 1.3 | 2.6 | 89 |
| 14 | 1.0 | 0.8 | 80 |
| 15 | 4.2 | 5.0 | 108 |
| 16 | 1.1 | 2.1 | 95 |
| 17 | 1.1 | 1.4 | 93 |
| 18 | 1.8 | 1.1 | 116 |
| 19 | 7.2 | 11.3 | 70 |
| 20 | 15.5 | 21.6 | 83 |
| 21 | 10.9 | 7.4 | 112 |
| 22 | 13.0 | 16.3 | 80 |
| 23 | 9.2 | 7.0 | 88 |
| 24 | 12.3 | 10.0 | 120 |
| 25 | 1.1 | 0.9 | 193 |
| 26 | 3.1 | 1.4 | 166 |
| 27 | 1.0 | 0.3 | 127 |
| 28 | 2.7 | 0.8 | 183 |
| 29 | 1.2 | 0.3 | 185 |
| 30 | 3.5 | 3.4 | 127 |
| 31 | 1.2 | 1.2 | 110 |
| 32 | 3.9 | 3.1 | 126 |
| 33 | 10.9 | 8.8 | 110 |
| 34 | 7.1 | 6.5 | 130 |
| 35 | 2.2 | 0.8 | 196 |
| 36 | 4.3 | 1.8 | 188 |
| 37 | 4.4 | 6.1 | 192 |
| 38 | 5.5 | 6.9 | 170 |
| 39 | 7.1 | 6.7 | 190 |
| 40 | 15.3 | 9.1 | 178 |
| 41 | 14.8 | 8.0 | 162 |
| 42 | 25.6 | 24.7 | 181 |
| 43 | 24.0 | 21.0 | 188 |
| 44 | 26.3 | 25.4 | 143 |

For TPUs with similar composition the recovery stress and energy output were higher for those polymers comprising FDCA. Moreover, the resilience to temperature of the FDCA TPUs was higher than for the IPHTA ones.

The invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A thermoplastic polyurethane composition comprising the reaction product of:
a. a polyester polyol comprising a short chain diol and 2,5-furandicarboxylic acid;
b. a diisocyanate component; and
c. a chain extender component.

2. The thermoplastic polyurethane composition according to claim 1, wherein the polyester polyol has a number average molecular weight lower than 5,000 Da.

3. The thermoplastic polyurethane composition according to claim 1, wherein the polyester polyol has a number average molecular weight in the range from 800 to 5,000 Da.

4. The thermoplastic polyurethane composition according to claim 1, wherein the diisocyanate is in an amount to provide a NCO:OH molar ratio of from 1:1.25 to 1.25:1.

5. The thermoplastic polyurethane composition according to claim 1, wherein the molar ratio of chain extender to polyol is from 1:1 to 1:9.

6. The thermoplastic polyurethane composition according to claim 1, wherein the molar ratio of 2,5-furandicarboxylic acid to short chain diol of the polyester polyol (a) is from 1:1 to 1:5.

7. The thermoplastic polyurethane composition according to claim 1, wherein the short chain diol is selected from the group consisting of 1,4-butanediol (BDO), 1,6-hexanediol (HDO), 1,3-propanediol (PDO), or mixtures thereof.

8. The thermoplastic polyurethane composition according to claim 1, wherein the chain extender component comprises 1,4-butanediol.

9. The thermoplastic polyurethane composition according to claim 1, wherein the chain extender component comprises 1,3-propanediol (PDO).

10. The thermoplastic polyurethane composition of claim 1, wherein the diisocyanate component is selected from diphenyl diisocyanate (MDI), hexamethylene diisocyanate (HDI), or mixtures thereof.

11. The thermoplastic polyurethane composition of claim 1, wherein the diisocyanate component comprises MDI.

12. The thermoplastic polyurethane composition of claim 1, wherein the diisocyanate component comprises HDI.

13. The thermoplastic polyurethane composition according to claim 1, wherein the thermoplastic polyurethane has a hard segment content of 2 to 50 wt. %.

14. The thermoplastic polyurethane composition according to claim 1, wherein the thermoplastic polyurethane shows a shore D hardness of at least 60, as determined by ISO 7619-1:2010.

15. The thermoplastic polyurethane composition according to claim 1, wherein the thermoplastic polyurethane shows a recovery stress of from 1 to 30 MPa.

16. The thermoplastic polyurethane composition according to claim 1, wherein the thermoplastic polyurethane shows energy output of from 0.6 to 30 MJ/m³.

17. A molded article comprising the thermoplastic polyurethane composition according to claim 1.

18. A molded article according to claim 17, wherein the molded article is a medical device.
